(19) United States
(12) Patent Application Publication
(10) Pub. No.: US 2021/0260693 A1
(43) Pub. Date: Aug. 26, 2021

(54) Laser Processing Device

(71) Applicant: Nippon Telegraph and Telephone Corporation, Tokyo (JP)

(72) Inventors: Sohan Kawamura, Tokyo (JP); Yuichi Akage, Tokyo (JP); Takashi Sakamoto, Tokyo (JP); Tadayuki Imai, Tokyo (JP)

(21) Appl. No.: 17/261,839

(22) PCT Filed: Aug. 2, 2019
(86) PCT No.: PCT/JP2019/030477

§ 371 Date: Jan. 20, 2021

(30) Foreign Application Priority Data
Aug. 29, 2018 (JP) 2018-160031

(51) Int. Cl. B23K 26/06; B23K 26/36

(52) U.S. Cl. CPC B23K 26/0643; B23K 26/0648; B23K 26/36

(57) ABSTRACT

A head portion for irradiating the surface of a structure to be processed with laser light and a diffractive optical element housed in the head portion are provided. Laser light emitted from a light source is delivered by an optical fiber and guided into the head portion through a light input portion of the head portion. The laser light delivered by the optical fiber is collimated by a collimator into parallel light and passes through the diffractive optical element, thereby producing shaped light with a broadened radiation distribution. The shaped light is emitted through an emitting portion of the head portion and is radiated onto a processing target surface of the structure to be processed.

This patent application is a national phase filing under section 371 of PCT/JP2019/030477, filed Aug. 2, 2019, which claims the priority of Japanese patent application 2018-160031, filed Aug. 29, 2018, each of which is incorporated herein by reference in its entirety.

### TECHNICAL FIELD

The present invention relates to a laser processing apparatus that performs a rust removal or coating film removal method using laser light.

### BACKGROUND

Laser processing apparatuses are widely used for cutting, welding, printing, or the like of metal, resin, or the like, and recently their scope of use is expanding to purposes of maintenance of structures such as so-called rust removal which removes rust on metal outdoors and removal of coating material on metal.

Currently, a metal brush, an electric tool, or an apparatus called a blaster which sprays sand or fine iron balls at high speed is used for such rust removal. However, the electric tool has problems where it is difficult to remove rust from an uneven portion of a steel material, it takes time to learn the technique, and the noise and the physical burden on the worker are significant. When the blaster is used, there are problems where it is necessary to surround a structure with a sheet to prevent scattering of sprayed sand or iron balls, noise is loud, and cleaning after work takes time.

On the other hand, a laser processing apparatus has many advantages such as noise suppression, rust removal of an uneven portion of metal, and easy collection of scattered materials (see Patent Literature 1 and Non Patent Literature 1). This laser processing apparatus for rust removal includes a laser light source and a processing head, and it is common to perform work while holding its head part by hand.

This laser processing apparatus includes an optical system such as a prism and a mechanism for rotating the optical system inside the head. With these mechanisms, the laser processing apparatus optimizes an energy density, a scanning range, a scanning speed, or the like to realize conditions optimal for rust removal, for example, by circularly scanning and emitting laser light from the head. The mechanisms of the laser processing apparatus have been devised to increase the area to complete a rust removal work per unit time to improve work efficiency.

### CITATION LIST

### Patent Literature

Patent Literature 1: JP 5574354B

### Non Patent Literature

Non Patent Literature 1: “Laser cleaning method: Method for removing coating film and rust using portable laser”, Technology Management Section in Transportation Infrastructure Department of Shizuoka Prefecture, New Technique/New Method Information Database, Registration No. 1624, [retrieved Aug. 23, 2018], (http://www2.pref.shizuoka.jp/all/new_technique.nsf/7BFBD8898312FB56492581930029788E/$FILE/1624gaiyou.pdf).

### SUMMARY

### Technical Problem

However, the laser processing apparatus described above has problems where the head part is heavy and long-time usage is a burden because a mechanical drive part for rotating the optical system is built in the head part. Further, there is a problem where it is difficult to remove rust from a narrow portion because the head part is large as described above.

Embodiments of the present invention have been made to solve the above problems and it is an object of embodiments of the present invention to make the head part of the laser processing apparatus lighter and smaller without lowering the processing capability.

### Means for Solving the Problem

A laser processing apparatus according to embodiments of the present invention includes a head portion for irradiating a surface of a structure to be processed with laser light supplied from a laser light source and a diffractive optical element housed in the head portion for broadening a radiation distribution of laser light.

In the laser processing apparatus, the diffractive optical element is removable.

In the laser processing apparatus, the diffractive optical element is a transmissive type. Alternatively, the diffractive optical element is a reflective type.

The laser processing apparatus may further include a reflecting portion for changing an optical path of laser light emitted from the head portion.

### Effects of Embodiments of the Invention

According to embodiments of the present invention, the radiation distribution of the laser light is broadened using the diffractive optical element as described above, thereby achieving an excellent effect of allowing the head part of the laser processing apparatus to be made lighter and smaller without lowering the processing capability.

### BRIEF DESCRIPTION OF THE DRAWINGS

FIG. 1 is a configuration diagram illustrating a configuration of a laser processing apparatus according to a first embodiment of the present invention.

FIG. 2 is a distribution diagram illustrating an intensity distribution of light (laser light) incident on a diffractive optical element.

FIG. 3 is an explanatory diagram illustrating an example of a radiation distribution changed (shaped) by the diffractive optical element.

FIG. 4 is a configuration diagram illustrating a configuration of a laser processing apparatus according to a second embodiment of the present invention.

FIG. 5 is a configuration diagram illustrating a configuration of a laser processing apparatus according to a third embodiment of the present invention.

FIG. 6 is a configuration diagram illustrating a configuration of a laser processing apparatus according to a fourth embodiment of the present invention.

### DETAILED DESCRIPTION OF ILLUSTRATIVE EMBODIMENTS

A laser processing apparatus according to embodiments of the present invention will be described below.

### First Embodiment

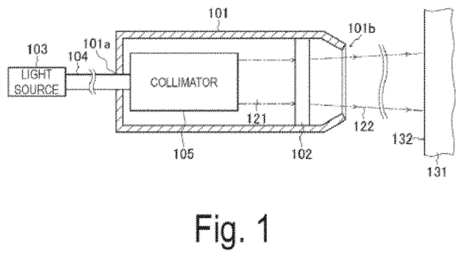

First, a laser processing apparatus according to a first embodiment of the present invention will be described with reference to FIG. 1. This laser processing apparatus includes a head portion 101 for irradiating the surface of a structure 131 to be processed with laser light and a diffractive optical element 102 housed in the head portion 101. The diffractive optical element 102 is fixed inside the head portion 101. The diffractive optical element 102 according to the first embodiment is a transmissive type.

Laser light emitted from a light source 103 is delivered by an optical fiber 104 and guided into the head portion 101 through a light input portion 101a of the head portion 101. The laser light delivered by the optical fiber 104 is collimated by a collimator 105 into parallel light 121 and passes through the diffractive optical element 102, thereby producing shaped light 122 with a broadened radiation distribution. The shaped light 122 is emitted through an emitting portion 101b of the head portion 101 and is radiated onto a processing target surface 132 of the structure 131 to be processed. Radiation of the shaped light 122 removes, for example, rust on the processing target surface 132.

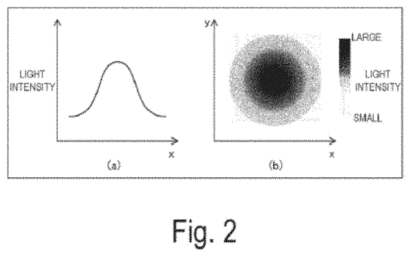

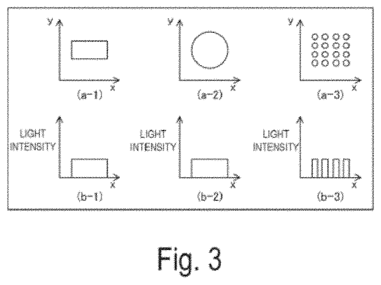

For example, the radiation distribution of the parallel light 121 has a circular shape in which the intensity of light increases toward the center as shown in FIG. 2. By using the diffractive optical element 102, radiation distributions as shown in FIG. 3 can be obtained. For example, rectangular radiation amount distributions in which the intensity of light is uniform within rectangular radiation regions as shown in (a-1) and (b-1) of FIG. 3 can be obtained. Further, circular radiation amount distributions in which the intensity of light is uniform within circular radiation regions as shown in (a-2) and (b-2) of FIG. 3 can be obtained. Furthermore, multiple-island radiation amount distributions in which the intensity of light is uniform in each island radiation region as shown in (a-3) and (b-3) of FIG. 3 can be obtained. By using the diffractive optical element 102, processing performance (capability) can be achieved without reducing the work range per unit time as compared with the conventional laser processing apparatus that uses an optical system such as a prism and a mechanism for rotating the optical system.

The diffractive optical element 102 can be made of, for example, a plate member of a transparent material such as ZnS or quartz. The diffractive optical element 102 can be obtained by forming a predetermined fine shape (diffraction pattern) on a surface of the plate member through known fine processing. The diffractive optical element 102 has a weight of about several tens of grams and the head portion 101 can be made smaller and lighter than when an optical system such as a prism and a mechanism for rotating the optical system are used. Further, the shape and size of the diffractive optical element 102 can be easily set (changed) and thus it is easy to make it fitted to the size and shape of the head portion 101. Furthermore, the head portion 101 can be made at a price similar to or lower than that of the mechanical drive mechanism because the price of the diffractive optical element 102 is several hundreds of thousands of yen.

There are cases where it is preferable that the shape of the light intensity distribution is rectangular or is in the shape of dots depending on work content and the processing target. In this regard, if the diffractive optical element 102 is made removable and replaceable, various shapes of light intensity distributions can be formed using the single head portion 101 and work can be performed efficiently using the single apparatus in various situations.

The light source 103 may be made of either a CW laser or a pulse laser. From an experiment in which a steel plate on which red rust has occurred is irradiated with a laser to remove rust, it has been found that red rust can be removed if the energy density is several J/mm². Thus, it is only required that the output of the light source 103 can be adjusted such that the light intensity distribution of the shaped light 122 is several J/mm².

The head portion 101 can be formed to have a size similar to, for example, that of a plastic bottle having an internal capacity of 500 mL. The head portion 101 can also be made at a weight of about 200 g and the weight can be reduced to about one-third that of a blaster or an electric tool so that the head portion 101 can be held with one hand.

The intensity of the laser light output from the light source 103 was adjusted such that the light intensity distribution of the shaped light 122 obtained by the diffractive optical element 102 was 8 mJ/mm² and a rust removal work was actually performed on an area of 500 mm×500 mm. As a result, the work was completed in about half the time as compared with rust removal using an electric tool and a blaster. Further, rust on an uneven portion of a metal surface to be processed was also removed. Further, the laser processing apparatus using the head portion 101 according to the first embodiment can achieve processing (rust removal) capability similar to that of the conventional laser processing apparatus that uses an optical system such as a prism and a mechanism for rotating the optical system.

A rust removal work and a coating removal work using the head portion 101 described above do not require a sheet around a structure or the like, which are required when an electric tool or a blaster is used, and can also reduce noise generated during the work by about 20 dB. Further, the head portion 101 can be made smaller and lighter than the head portion of the conventional laser processing apparatus that uses an optical system such as a prism and a mechanism for rotating the optical system.

### Second Embodiment

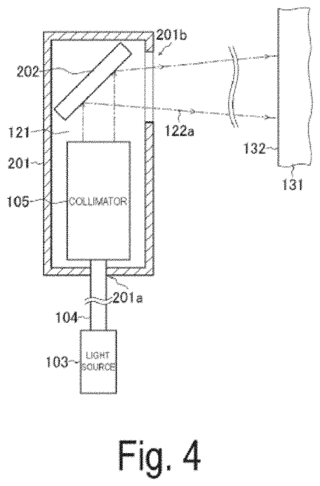

Next, a laser processing apparatus according to a second embodiment of the present invention will be described with reference to FIG. 4. This laser processing apparatus includes a head portion 201 for irradiating the surface of a structure 131 to be processed with laser light and a diffractive optical element 202 housed in the head portion 201. The diffractive optical element 202 is fixed inside the head portion 201. The diffractive optical element 202 according to the second embodiment is a reflective type. The same reference signs as those of the first embodiment described above are used for the same components.

Laser light emitted from a light source 103 is delivered by an optical fiber 104 and guided into the head portion 201 through a light input portion 201a of the head portion 201. The laser light delivered by the optical fiber 104 is collimated by a collimator 105 into parallel light 121 and reflected by the diffractive optical element 202, thereby producing shaped light 122a with a broadened radiation distribution. The shaped light 122a is emitted through an emitting portion 201b of the head portion 201 and is radiated onto a processing target surface 132 of the structure 131 to be processed. Radiation of the shaped light 122a removes, for example, rust on the processing target surface 132.

For example, the radiation distribution of the parallel light 121 has a circular shape in which the intensity of light increases toward the center as described above. By using the reflective-type diffractive optical element 202, various radiation distributions can also be obtained as described with reference to FIG. 3. By using the diffractive optical element 202, processing performance (capability) can also be achieved without reducing the work range per unit time as compared with the conventional laser processing apparatus that uses an optical system such as a prism and a mechanism for rotating the optical system.

The diffractive optical element 202 can be made of, for example, a plate member of a transparent material such as ZnS or quartz. The diffractive optical element 202 can be obtained by forming a predetermined fine shape (diffraction pattern) on a surface of the plate member through known fine processing. The diffractive optical element 202 has a weight of about several tens of grams and the head portion 201 can be made smaller and lighter than when an optical system such as a prism and a mechanism for rotating the optical system are used. Further, the shape and size of the diffractive optical element 202 can be easily set (changed) and thus it is easy to make it fitted to the size and shape of the head portion 201. Furthermore, the head portion 201 can be made at a price similar to or lower than that of the mechanical drive mechanism because the price of the diffractive optical element 202 is several hundreds of thousands of yen.

There are cases where it is preferable that the shape of the light intensity distribution is rectangular or is in the shape of dots depending on work content and the processing target. In this regard, if the diffractive optical element 202 is made removable and replaceable, various shapes of light intensity distributions can be realized using the single head portion 201 and work can be performed efficiently using the single apparatus in various situations.

The head portion 201 can be formed to have a size similar to, for example, that of a plastic bottle having an internal capacity of 500 mL and can also be made at a weight of about 200 g. The intensity of the laser light output from the light source 103 was adjusted such that the light intensity distribution of the shaped light 122a obtained by the diffractive optical element 202 was 8 mJ/mm² and a rust removal work was actually performed on an area of 500 mm×500 mm. As a result, the work was completed in about half the time as compared with rust removal using an electric tool and a blaster. Further, rust on an uneven portion of a metal surface to be processed was also removed. Further, the laser processing apparatus using the head portion 201 according to the second embodiment can achieve processing (rust removal) capability similar to that of the conventional laser processing apparatus that uses an optical system such as a prism and a mechanism for rotating the optical system.

A rust removal work and a coating removal work using the head portion 201 described above do not require a sheet around a structure or the like, which are required when an electric tool or a blaster is used, and can also reduce noise generated during the work by about 20 dB. Further, the head portion 201 can be made smaller and lighter than the head portion of the conventional laser processing apparatus that uses an optical system such as a prism and a mechanism for rotating the optical system.

### Third Embodiment

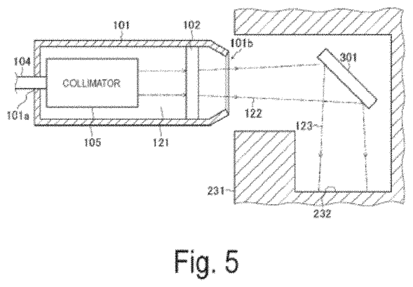

Next, a laser processing apparatus according to a third embodiment of the present invention will be described with reference to FIG. 5. This laser processing apparatus includes a head portion 101 for irradiating the surface of a structure 131 to be processed with laser light and a diffractive optical element 102 housed in the head portion 101. The diffractive optical element 102 according to the third embodiment is a transmissive type.

Laser light emitted from a light source 103 is delivered by an optical fiber 104 and guided into the head portion 101 through a light input portion 101a of the head portion 101. The laser light delivered by the optical fiber 104 is collimated by a collimator 105 into parallel light 121 and passes through the diffractive optical element 102, thereby producing shaped light 122 with a broadened radiation distribution. The shaped light 122 is emitted through an emitting portion 101b of the head portion 101.

The components described above are the same as those of the first embodiment. The third embodiment further includes a reflecting portion 301 for changing the optical path of the shaped light (laser light) 122 emitted through the emitting portion 101b of the head portion 101.

In the third embodiment, the shaped light 122 emitted through the emitting portion 101b of the head portion 101 is reflected by the reflecting portion 301 which changes the traveling direction of the shaped light 122, and shaped light 123 obtained by changing the traveling direction of the shaped light 122 is radiated onto a processing target surface 232 of the structure 231 to be processed. The processing target surface 232 in the structure 231 is at the back of a bent hole of the structure 231 at a position where it cannot be viewed from the entrance of the hole. However, the processing target surface 232 can be irradiated by changing the traveling direction of the shaped light 122 to obtain the shaped light 123 using the reflecting portion 301. Radiation of the shaped light 123 removes, for example, rust on the processing target surface 232.

It was possible to perform a rust removal work on the narrow processing target surface 232 of 50 mm×1000 mm at the back of the bent hole of the structure 231, which was difficult in the related art, as a result of performing the rust removal work according to the third embodiment.

The reflecting portion 301 may be, for example, a plane mirror, a concave mirror, or a convex mirror. A plane mirror, a concave mirror, or a convex mirror may be appropriately selected according to the state of the processing target. A plurality of reflecting portions may also be used according to the usage.

In the third embodiment, a rust removal work and a coating removal work using the head portion 101 do not require a sheet around a structure or the like, which are required when an electric tool or a blaster is used, and can also reduce noise generated during the work by about 20 dB, similar to the first embodiment described above. Further, the head portion 101 can be made smaller and lighter than the head portion of the conventional laser processing apparatus that uses an optical system such as a prism and a mechanism for rotating the optical system.

### Fourth Embodiment

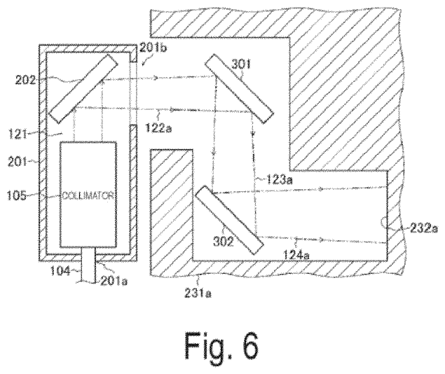

Next, a laser processing apparatus according to a fourth embodiment of the present invention will be described with reference to FIG. 6. This laser processing apparatus includes a head portion 201 for irradiating the surface of a structure 231a to be processed with laser light and a diffractive optical element 202 housed in the head portion 201. The diffractive optical element 202 according to the fourth embodiment is a reflective type.

Laser light emitted from a light source 103 is delivered by an optical fiber 104 and guided into the head portion 201 through a light input portion 201a of the head portion 201. The laser light delivered by the optical fiber 104 is collimated by a collimator 105 into parallel light 121 and reflected by the diffractive optical element 202, thereby producing shaped light 122a with a broadened radiation distribution. The shaped light 122a is emitted through an emitting portion 201b of the head portion 201.

The components described above are the same as those of the second embodiment. The fourth embodiment further includes a reflecting portion 301 and a reflecting portion 302 for changing the optical path of the shaped light (laser light) 122a emitted through the emitting portion 201b of the head portion 201.

In the fourth embodiment, the shaped light 122a emitted through the emitting portion 201b of the head portion 201 is reflected first by the reflecting portion 301 which changes the traveling direction of the shaped light 122a. Next, shaped light 123a obtained by the reflecting portion 301 changing the traveling direction of the shaped light 122a is reflected by the reflecting portion 302 which changes the traveling direction of the shaped light 123a. Thus, shaped light 124a obtained by changing the traveling direction of the shaped light 123a is radiated onto a processing target surface 232a of the structure 231a to be processed.

The processing target surface 232a in the structure 231a is at the back of a complicated bent hole of the structure 231a at a position where it cannot be viewed from the entrance of the hole. However, the processing target surface 232a can be irradiated by changing the traveling direction of the shaped light 122a to obtain the shaped light 123 using the reflecting portion 301 and further changing the traveling direction of the shaped light 123a to obtain the shaped light 124a using the reflecting portion 302. Radiation of the shaped light 124a removes, for example, rust on the processing target surface 232a.

It was possible to perform a rust removal work on the narrow processing target surface 232a of 50 mm×1000 mm at the back of the bent hole of the structure 231a, which was difficult in the related art, as a result of performing the rust removal work according to the fourth embodiment.

Each of the reflecting portions 301 and 302 maybe, for example, a plane mirror, a concave mirror, or a convex mirror. A plane mirror, a concave mirror, or a convex mirror may be appropriately selected according to the state of the processing target.

In the fourth embodiment, a rust removal work and a coating removal work using the head portion 201 do not require a sheet around a structure or the like, which are required when an electric tool or a blaster is used, and can also reduce noise generated during the work by about 20 dB, similar to the second embodiment described above. Further, the head portion 201 can be made smaller and lighter than the head portion of the conventional laser processing apparatus that uses an optical system such as a prism and a mechanism for rotating the optical system.

Incidentally, studies by the inventors have showed that currently and commonly available diffractive optical elements can be bent (deformed) by applying stress. For example, by applying stress to a plate-shaped diffractive optical element from the side periphery thereof, it is possible to make the diffractive optical element curved with one surface concave and the other convex. For example, the diffractive optical element can be curved to have a height difference (step) of several tens of μm between the center and end portions thereof. The diffractive optical element can be curved, for example, using a clamping device whose drive source is a plunger or the like. The function of a convex mirror or a concave mirror can be added, for example, to a reflective-type diffractive optical element by curving the diffractive optical element in such a way.

According to embodiments of the present invention, the radiation distribution of laser light is broadened using the diffractive optical element as described above, so that the head part of the laser processing apparatus can be made lighter and smaller without lowering the processing capability.

It should be noted that the present invention is not limited to the embodiments described above and it will be apparent that many modifications and combinations can be implemented by a person having ordinary knowledge in the art without departing from the technical spirit of the present invention.

1.-5. (canceled)

6. A laser processing apparatus comprising:
a head portion configured to irradiate a surface of a structure to be processed with laser light from a laser light source; and
a diffractive optical element housed in the head portion and configured to broaden a radiation distribution of the laser light.

7. The laser processing apparatus according to claim 6, wherein the diffractive optical element is removable.

8. The laser processing apparatus according to claim 6, wherein the diffractive optical element is a transmissive type.

9. The laser processing apparatus according to claim 6, wherein the diffractive optical element is a reflective type.

10. The laser processing apparatus according to claim 6, further comprising a reflecting portion configured to change an optical path of the laser light emitted from the head portion.

11. The laser processing apparatus according to claim 6, wherein the diffractive optical element comprises a plate member of a transparent material comprising ZnS or quartz.

12. A laser processing apparatus comprising:
a head portion configured to receive laser light emitted from a light source;
a collimator housed in the head portion and configured to collimate the laser light emitted from the light source into parallel light; and
a diffractive optical element housed in the head portion and configured to receive the parallel light from the collimator and produce a shaped light with a broadened radiation distribution.

13. The laser processing apparatus according to claim 12, wherein the head portion comprises:
a light input portion configured to guide the laser light emitted from the light source into the head portion; and
an emitting portion configured to emit the shaped light from the head portion.

14. The laser processing apparatus according to claim 12, wherein the head portion is configured to direct the shaped light to a processing target surface of a structure to be processed by the shaped light.

15. The laser processing apparatus according to claim 12, further comprising a first reflecting portion configured to receive and change an optical path of the shaped light emitted from the head portion.

16. The laser processing apparatus according to claim 15, further comprising a second reflecting portion configured to receive and change an optical path of the shaped light emitted from the first reflecting portion.

17. The laser processing apparatus according to claim 12, wherein the diffractive optical element is removable.

18. The laser processing apparatus according to claim 12, wherein the diffractive optical element is a transmissive type.

19. The laser processing apparatus according to claim 12, wherein the diffractive optical element is a reflective type.

20. A method of operating a laser processing apparatus, the method comprising:
receiving, by a head portion, laser light emitted from a light source;
collimating, by a collimator housed in the head portion, the laser light emitted from the light source into parallel light;
receiving, by a diffractive optical element housed in the head portion, the parallel light from the collimator and producing a shaped light with a broadened radiation distribution; and
processing a target surface of a structure using the shaped light produced by the diffractive optical element.

21. The method according to claim 20, further comprising changing, by a first reflecting portion, an optical path of the shaped light produced by the diffractive optical element before processing the target surface of the structure.

22. The method according to claim 20, wherein the diffractive optical element is removable.

23. The method according to claim 20, wherein the diffractive optical element is a transmissive type.

24. The method according to claim 20, wherein the diffractive optical element is a reflective type.

25. The method according to claim 20, wherein processing the target surface of the structure comprises removing rust from the target surface of the structure.
